(19) United States
(12) Patent Application Publication
(10) Pub. No.: US 2009/0020617 A1
(43) Pub. Date: Jan. 22, 2009

(54) BARCODE MARKING METHOD AND APPARATUS FOR ELECTRO-LUMINESCENCE DISPLAY DEVICE

(75) Inventors: Seung Ho KWON, Seoul (KR); Byung Sao KIM, Kumi-Si (KR); Jin Ho SUNWOO, Kumi-Si (KR); Yoon Heung TAK, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/128,483

(22) Filed: May 28, 2008

Related U.S. Application Data
(63) Continuation-in-part of application No. 11/819,440, filed on Jun. 27, 2007.
Application No. 11/819,440 is a continuation of application No. 10/960,968, filed on Oct. 12, 2004, now Pat. No. 7,311,396.

(30) Foreign Application Priority Data
Oct. 13, 2003 (KR) P2003-71075

(51) Int. Cl. G06K 19/06

(52) U.S. Cl. 235/494

(57) ABSTRACT

An organic electro-luminescence device including a substrate, a first electrode, a light-emitting layer and a second electrode which are sequentially formed on the substrate, a packaging plate facing the substrate, and barcodes formed on the substrate and the packaging plate.

This application is a Continuation-in-part of co-pending application Ser. No. 11/819,440 filed on Jun. 6, 2007, which is a Continuation of application Ser. No. 10/960,968 filed on Oct. 12, 2004, now U.S. Pat. No. 7,311,396, which issued on Dec. 25, 2007, and which all claim the benefit of Korean Patent Application No. P2003-71075 filed in Korea on Oct. 13, 2003, the entire contents of all documents are hereby incorporated by reference.

### BACKGROUND OF THE INVENTION

1. Field Of The Invention

The present invention relates to an electro-luminescence display device, and more particularly, to barcodes formed on an electro-luminescence display device for improving a production yield.
2. Description Of The Related Art

Recently, there have been highlighted various flat panel display devices reduced in weight and bulk that are capable of eliminating disadvantages of a cathode ray tube (CRT). Such flat panel display devices include a liquid crystal display (LCD) device, a field emission display (FED) device, a plasma display panel (PDP), an electro-luminescence (EL) display and the like.

Among these, the EL display device is a spontaneous light-emitting device capable of light-emitting a phosphorous material by a re-combination of electrons with holes. The EL display device is generally classified into an inorganic EL device using an inorganic compound as the phosphorous material and an organic EL device using an organic compound as the phosphorous material. The EL display device has many advantages of a low voltage driving, a self-luminescence, a thin-thickness, a wide viewing angle, a fast response speed and a high contrast, etc. such that it can be highlighted into a post-generation display device.

Meanwhile, it is common that the EL display device has no marks thereon, e.g., on its sectional surface, but it is a current trend to mark an information barcode on the EL display device for identification. According to the international organization for standardization ISO, it is required that the information barcode should be marked on the sectional surface of the EL display device. Accordingly, in order to mark the information barcode on the sectional surface of the EL display device, there are employed several methods including a manual labor method using a marking pen, a method of etching a substrate of the EL display device using a laser to directly mark the information barcode inside the EL display device, and a method of sticking a sticker having a printed information barcode on a rear surface of the EL display device.

However, the manual labor method using the marking pen is applicable to a large-sized display device, but it is difficult to apply this method to a small-sized display device as an EL display device. Also, since the manual labor is manually performed, there is a problem that a production yield is deteriorated. The method of etching the substrate of the EL display device using the laser has a disadvantage in that a repair of the EL display device is impossible when an information barcode is wrongly marked, or when a problem occurs during the marking process of the information barcode. Further, the method of sticking the sticker having the printed information barcode on the rear surface of the EL display device has a disadvantage in that the sticker is easily detached from the EL display device, and a repair operation is also difficult.

### SUMMARY OF THE INVENTION

Accordingly, one object of the present invention is to provide an organic electro-luminescence device including barcodes formed on a substrate and packaging plate capable of improving a production yield.

In order to achieve these and other objects of the invention, the present invention provides in one aspect an organic electro-luminescence device including a substrate, a first electrode, a light-emitting layer and a second electrode which are sequentially formed on the substrate, a packaging plate facing the substrate, and barcodes formed on the substrate and the packaging plate.

In another aspect, the present invention provides an organic electro-luminescence device including a substrate, a first electrode, a light-emitting layer and a second electrode which are sequentially formed on the substrate, a packaging plate facing the substrate, and a barcode formed on an edge of at least one of the substrate and the packaging plate.

In still another aspect, the present invention provides an organic electro-luminescence device including a substrate, a first electrode, a light-emitting layer and a second electrode which are sequentially formed on the substrate, a packaging plate facing the substrate, and barcodes formed on the substrate and the packaging plate, wherein the barcodes are disposed outwardly from a sealing portion.

In still another aspect, the present invention provides an organic electro-luminescence device including a substrate, a first electrode, a light-emitting layer and a second electrode which are sequentially formed on the substrate, a packaging plate facing the substrate, and a first barcode and a second barcode formed on the substrate and the packaging plate, respectively, wherein the first barcode and the second barcode are inverted to each other.

In another aspect, the present invention provides an organic electro-luminescence device including a substrate, a first electrode, a light-emitting layer and a second electrode which are sequentially formed on the substrate, a packaging plate facing the substrate, and a first barcode and a second barcode formed on the substrate and the packaging plate, respectively, wherein the first barcode is formed by printing ink and the second barcode is formed by etching with a laser.

### BRIEF DESCRIPTION OF THE DRAWINGS

These and other objects of the invention will be apparent from the following detailed description of the embodiments of the present invention with reference to the accompanying drawings, in which:

FIG. 1 is a block diagram representing a barcode marking device for an electro-luminescence display device according to an embodiment of the present invention;

FIG. 2 is a sectional view fully illustrating the electro-luminescence display device shown in FIG. 1;

FIG. 3 is a sectional diagram illustrating an organic light-emitting layer in the electro-luminescence display device shown in FIG. 2;

FIG. 4 shows a detailed ink-jet marker in the barcode marking device for the electro-luminescence display device shown in FIG. 1;

FIGS. 5A to 5B illustrate an information barcode marked in the electro-luminescence display device by using the barcode marking device for the electro-luminescence display device shown in FIG. 1;

FIG. 6 is an overview showing an organic electro-luminescence device according to one exemplary embodiment of the invention;

FIGS. 7A and 7B illustrate examples of sub-pixel circuits of the organic electro-luminescence device according to exemplary embodiments of the invention;

FIGS. 8A to 8E illustrate embodiments for realizing a color image in an organic electro-luminescence device;

FIG. 9A is a cross-sectional view of an organic electro-luminescence device according to an embodiment of the invention;

FIG. 9B is an enlarged view of a portion of FIG. 9A;

FIGS. 9C and 9D are cross-sectional views of additional exemplary embodiments of organic electro-luminescence devices according to the invention;

FIGS. 10A and 10B are perspective views of a substrate including indicia on a face thereof; and

FIG. 11 is an expanded view of a portion of the electro-luminescence device of FIG. 8A.

### DETAILED DESCRIPTION OF THE PREFERRED EMBODIMENT

Reference will now be made in detail to the preferred embodiments of the present invention, examples of which are illustrated in the accompanying drawings.

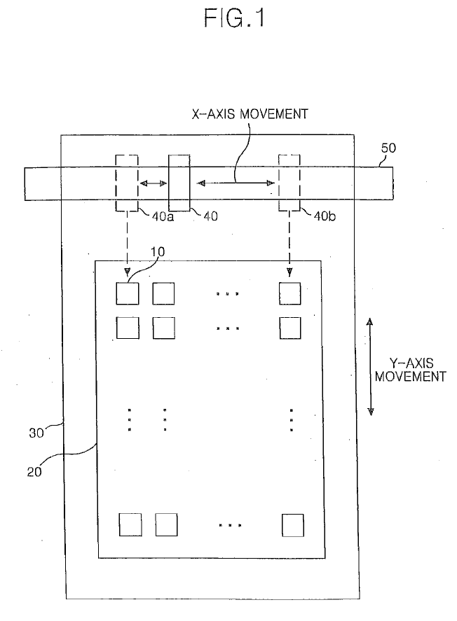

Hereinafter, the preferred embodiments of the present invention will be described in detail with reference to FIGS. 1 to 11.

FIG. 1 is a block diagram representing a barcode marking device for an electro-luminescence display device according to an embodiment of the present invention. Referring to FIG. 1, the barcode marking device includes a stage 30; a substrate 20 mounted on the stage 30; a plurality of EL display devices 10 formed on the substrate 20; an ink-jet marker for marking an information barcode in the EL display devices 10; and an ink-jet driver 50 for supporting and driving the ink-jet marker 40.

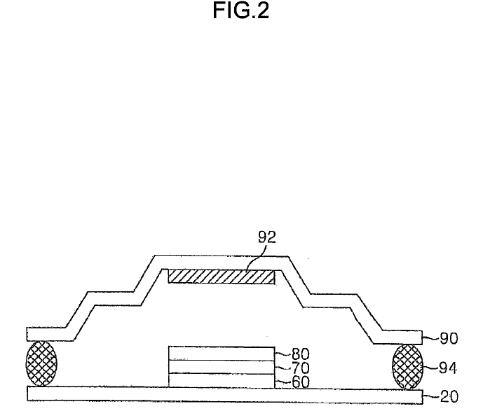

As shown in FIG. 2, the EL display devices 10 includes an anode electrode 60 with a transparent electrode pattern on the substrate 20 and an organic light-emitting layer 70 stacked on the anode electrode 60. A cathode electrode 80 as a metal electrode is formed on the organic light-emitting layer 70. Also, because the organic light-emitting layer 70 is apt to be damaged by moisture and oxygen in the atmosphere, a packaging plate 90 is formed in order to protect the organic light-emitting layer 70. Further, the packaging plate 90 is made of material such as glass, plastic or canister, and includes a first horizontal surface on which a sealant 94 is applied, a second horizontal surface having a designated step height from the first horizontal surface, and a third horizontal surface having a designated step height from the second horizontal surface.

A getter 92 is also attached on a bottom surface of the third horizontal surface in the packaging plate 90 to absorb the moisture and the oxygen. The getter 92 includes a powder getter material such as barium oxide (BaO) or calcium oxide (CaO) enveloped by a polyethylene system package. A net is also adhered on one side of the packaging paper in order to make the oxygen and the moisture go in and out.

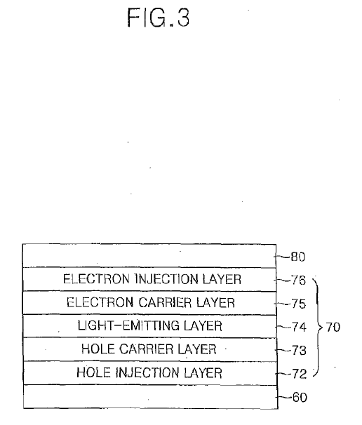

As shown in FIG. 3, the organic light-emitting layer 70 stacked between the anode electrode 60 and the cathode electrode 80 includes an electron injection layer 76, an electron carrier layer 75, a light-emitting layer 74, a hole carrier layer 73, and a hole injection layer 72.

Thus, when a voltage is applied between the anode electrode 60 and the cathode electrode 80, electrons produced from the cathode electrode 80 are moved, via the electron injection layer 76 and the electron carrier layer 75, into the light-emitting layer 74. Moreover, holes produced from the anode electrode 60 are moved, via the hole injection layer 72 and the hole carrier layer 73, into the light-emitting layer 74. Therefore, the electrons and the holes supplied from the electron carrier layer 75 and the hole carrier layer 73, respectively, are collided at the light-emitting layer 74, so that they are recombined to thereby generate light. The recombined light is then emitted, via the anode electrode 60 of the transparent electrode, into the exterior to thereby represent a picture. In addition, because a light-emitting brightness of the organic EL device is in proportion to a supplied current rather than in proportion to a voltage applied to both ends of the EL device, the anode electrode is commonly connected to a constant current source.

Further, the stage 30 is supported by a stage driver (not shown) and is moved along a Y-axis direction. After the substrate 20 having the EL display devices 10 formed thereon is disposed on the stage 30, the stage 30 is sequentially moved along the Y-axis direction in order to mark the information barcode by using the ink-jet marker 40 on the EL display devices 10 arranged on a row and column basis on the substrate 20. More specifically, after the information barcode is marked on all of the EL display devices 10 arranged in one row in the substrate 20, the stage 30 is moved along the Y-axis direction in order to mark the information barcode on the other EL display device 10 arranged in the next row.

Also, the ink-jet marker 40 functions to mark the information barcode for the EL display device by using an ink-jet system on the packaging plate 90 of the EL display devices. The information barcode for the EL display devices 10 includes various information such as a date representing the time when the EL display device 10 is made, a property of the EL display device 10 and the like. At this time, the information barcode for the EL display devices 10 has information different from each other in order to identify the respective EL display devices 10.

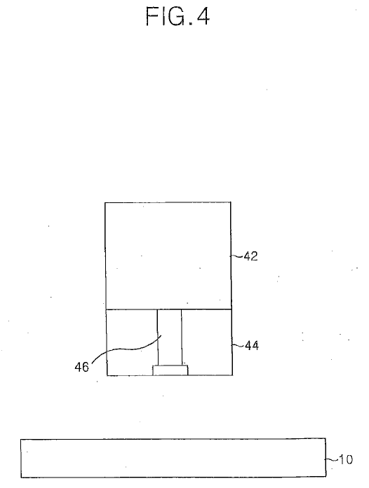

Meanwhile, the ink-jet system includes a thermal system or a piezoelectric system. The piezoelectric system among these is preferably used. As shown in FIG. 4, the ink-jet marker 40 for the piezoelectric system 50 includes a vessel 42 for containing a material to be jetted, and an ink-jet head 44 for jetting the material supplied from the vessel 42. Further, the vessel 42 is filled with the ink, and an ink-jet head is provided with a piezoelectric element and a nozzle 46 for jetting the ink contained in the vessel 42. Also, when a voltage is applied to the piezoelectric element, a physical pressure is produced to repeatedly cause a contraction and a relaxation of a flow path between the vessel 42 and the nozzle 46. Owing to this repeated contraction and relaxation, the ink is jet through the nozzle 46. The ink-jet marker 40 then jets the ink to the EL display devices 10 while being moved by the ink-jet driver 50 along a X-axis direction to thereby mark the information barcode for the EL display devices 10. Herein, the inkjet marker 40 is controlled by a system (not shown) to mark a desired information to each of the EL display devices 10.

A marking method using a barcode marking device for the EL display device will now be described in more detail. First of all, the substrate 20 having the EL display devices 10 is disposed on the stage 30. The EL display devices 10 arranged in a first column is located at a place in which the ink-jet marker 40 is located by moving the stage 30 along the Y-axis direction. Then, the desired information barcode is marked on each of the EL display devices 10 by the ink-jet marker 10 moving from a first location 40a to a second location 40b along the X-axis direction by the ink-jet driver 50. Herein, the first location 40a corresponds to a location of a first EL display device 10 arranged in one row on the substrate 20 having the EL display devices 10. The second location 40b corresponds to a location of a last EL display device 10 arranged in the row on the substrate 20.

When the information barcode is marked on all of the EL display devices 10 arranged in the first row, the ink-jet marker 40 located in the second location 40b is moved again to the first location 40a. Then, the stage 30 is moved along the Y-axis direction on a one column basis so that the EL display devices 10 arranged in a subsequent row is located at a place in which the inkjet marker 40 is located. Next, the information barcode is marked on each of the EL display devices 10 by the ink-jet marker 40 moving from the first location 40a to the second location 40b along the X-axis direction by the ink-jet driver 50. The above operation is then repeated until the information barcode is marked on all of the EL display devices 10 arranged in a last row.

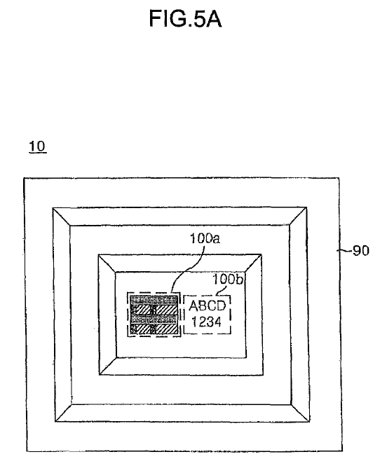

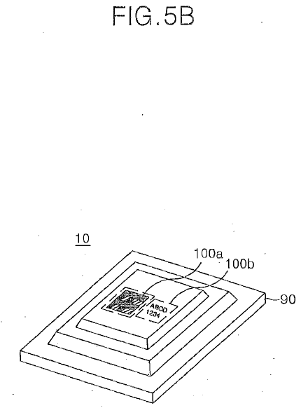

Alternatively, the present invention is also applicable to mark two information barcodes having the same information on the packaging plate 90 of the EL display device to prevent a problem of one information barcode being incorrectly marked on the EL display device 10. In other words, as shown in FIGS. 5A and 5B, the two information barcodes includes a two-dimension (2D) barcode 100a and a text barcode 100b. The two-dimension (2D) barcode 100a and the text barcode 100b are marked on the packaging plate 90 of the EL display device by the inkjet system in accordance with an embodiment of the present invention.

As described above, the information on the EL devices is stored by the two-dimension (2D) barcode 100a and the text barcode 100b when the information barcode for the EL display device is marked by the barcode marking device for the EL display device according to this embodiment of the present invention. Therefore, it is easy to manage the EL display devices. Also, when a marking problem occurs, the marking problem can be removed by using a solvent. Thus, it has an advantage that a repair is possible. Such an ink-jet method also has an advantage in that the time required to mark the information barcode is saved as compared with the method directly sticking the sticker through the use of the manual labor method by a worker or the method of etching the substrate by using the laser to mark the information barcode. Thus, it is profitable in a production yield.

As described above, according to the above embodiments of a barcode marking method and apparatus of the electro-luminescence display device of the present invention, the information barcode of the EL display device is marked using ink, to thereby remove the related art marking problem. As a result, a repair is possible, and the time required to mark the information barcode is reduced. Thus, it is possible to improve a production yield of the devices.

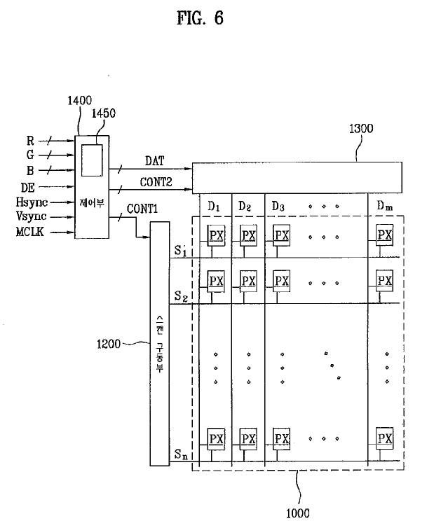

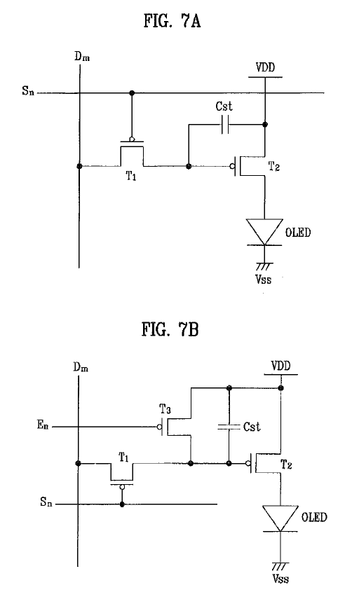

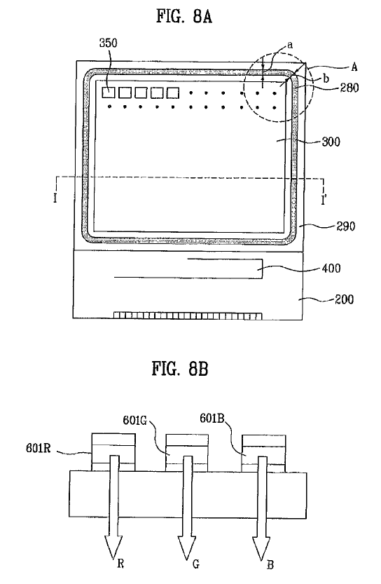

Next, referring to FIG. 6, the electro-luminescence display device according to another embodiment of the present invention includes a display panel 1000, a scan driving part 1200, a data driving part 1300 and a controller 1400.

As shown, the display panel 1000 includes a plurality of signal lines S1˜Sn and D1˜Dm, a plurality of power lines (not shown) and a plurality of sub-pixels PX connected thereto and arranged in a matrix. Further, the signal lines S1˜Sn and D1˜Dm include a plurality of scan lines S1˜Sn to transmit scan signals and a plurality of data lines D1˜Dm to transmit data signals. The respective power lines (not shown) supply a first source voltage VDD or the like to each of the sub-pixels PX.

Although the signal lines include only the scan lines S1˜Sn and the data lines D1˜Dm in the above description and the drawing, it is not limited thereto. That is, the signal lines may further include erase lines (not shown) to transmit erase signals according to a driving method.

However, even when the erase signals are used, the erase lines may be omitted. In this instance, the erase signals may be supplied through other lines. For example, when the display panel 1000 further includes the power lines for supplying the first source voltage VDD, the erase signals may be supplied through the power lines.

Referring to FIG. 7A, each of the sub-pixels PX may include a switching thin film transistor T1, which transmits a data signal based on a scan signal transmitted from the scan line Sn, a capacitor Cst which stores the data signal, a driving thin film transistor T2, which produces a driving current corresponding to a difference between the data signal stored in the capacitor Cst and the first source voltage VDD, and a light emitting diode (OLED) which emits light corresponding to the driving current.

Further, as shown in FIG. 7B, the sub-pixel may include a switching thin film transistor T1, which transmits a data signal based on a scan signal transmitted from the scan line Sn, a capacitor Cst which stores a data signal, a driving thin film transistor T2, which produces a driving current corresponding to a difference between the data signal stored in the capacitor Cst and the first source voltage VDD, a light emitting diode (OLED), which emits light corresponding to the driving current, and a switching thin film transistor T3 for erasing the data signal stored in the capacitor according to an erase signal transmitted from an erase line En.

As for the pixel circuit shown in FIG. 7B, when the electro-luminescence display device is driven by a digital driving method in which a frame is divided into a plurality of sub-fields to express gradation, it is possible to adjust a light emitting time period by supplying an erase signal to a sub-filed having a shorter light emitting time period than an address time period. Accordingly, there is an advantage of reducing a minimum brightness of the electro-luminescence display device.

In this instance, a driving voltage, that is, a difference between the first source voltage VDD and a second source voltage Vss, of the electro-luminescence display device according to an embodiment of the present invention may vary according to the size of the display panel and the driving method. The magnitude of the driving voltage is represented as follows:

<digital driving method>

| | VDD − Vss (R) | | VDD − Vss (G) | | VDD − Vss (B) | |
|---|---|---|---|---|---|---|
| S < 3 inches | 3.5~10 | (V) | 3.5~10 | (V) | 3.5~12 | (V) |
| 3 inches < S < | 5~15 | (V) | 5~15 | (V) | 5~20 | (V) |
| 20 inches | | | | | | |
| 20 inches < S | 5~20 | (V) | 5~20 | (V) | 5~25 | (V) |

S: size of display panel (unit: inches)

<analog driving method>

| | VDD − Vss (R, G, B) |
|---|---|
| S < 3 inches | 4~20 (V) |
| 3 inches < S < 20 inches | 5~25 (V) |
| 20 inches < S | 5~30 (V) |

S: size of display panel (unit: inches)

Referring to FIG. 6 again, the scan driving part 1200 is connected to the scan lines S1˜Sn of the display panel 1000 to apply scan signals capable of turning on first thin film transistors T1 to the scan lines S1˜Sn, respectively. The data driving part 1300 is connected to the data lines D1˜Dm of the display panel 1000 to apply data signals representing an output image signal DAT′ to the data lines D1˜Dm. The data driving part 1300 may include at least one data driving integrated circuit (IC) connected to the data lines D1˜Dm.

Further, the data driving IC may include a shift register, a latch, a digital-analog converter (DA converter) and an output buffer, which are sequentially connected thereto.

When the shift register receives a horizontal synchronization start signal (STH) (or a shift clock signal), the shift register transmits the output image signal DAT′ to the latch based on a data clock signal (HCLK). When the data driving part 1300 includes a plurality of data driving ICs, a shift register of one driving IC sends a shift clock signal to a shift register of the next driving IC.

In addition, the latch stores the output image signal DAT′ and sends the stored output image signal DAT′ to the output buffer by selecting a corresponding gradation voltage based on a load signal (LOAD). The digital-analog converter selects a corresponding gradation voltage according to the output image signal DAT′ and sends the corresponding gradation voltage to the output buffer.

Further, the output buffer outputs the output voltage sent from the digital-analog converter as a data signal to the data lines D1˜Dm. The output buffer continues to output the output voltage for one horizontal period (1H). In addition, the controller 1400 controls the operation of the scan driving part 1200 and the data driving part 1300. Further, the controller 1400 may include a signal converter 1450, which gamma-converts input image signals R, G and B, to produce the output image signal DAT′.

That is, after the controller 1400 produces a scan control signal CONT1 and a data control signal CONT2 and the like, the controller 1400 outputs the scan control signal CONT1 to the scan driving part 1200 and outputs the data control signal CONT2 and the processed output image signal DAT′ to the data driving part 1300.

Further, the controller 1400 receives the input image signals R, G and B and an input control signal for controlling a display thereof from an external graphic controller (not shown). For example, the input control signal includes a vertical synchronization signal Vsync, a horizontal synchronization signal Hsync, a main clock signal MCLK, a data enable signal DE and the like.

Such driving devices 1200, 1300 and 1400 may be mounted directly on the display panel 1000 while each device is formed in at least one integrated circuit chip. The driving devices 1200, 1300 and 1400 may also be mounted on a flexible printed circuit film (not shown) and then attached on the display panel 1000 in a tape carrier package (TCP). Further, the driving devices 1200, 1300 and 1400 may be mounted on an additional printed circuit board (not shown).

In a different way, the driving devices 1200, 1300 and 1400 may be integrated on the display panel 1000 with a plurality of the signal lines S1˜Sn and D1˜Dm, the thin film transistors T1, T2 and T3 or the like. Further, the driving devices 1200, 1300 and 1400 may be integrated in a single chip. In this case, at least one of the driving devices 1200, 1300 and 1400 or at least one circuit device thereof may be disposed at the outside of the single chip.

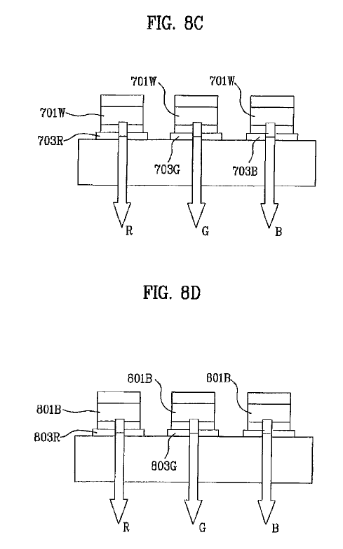

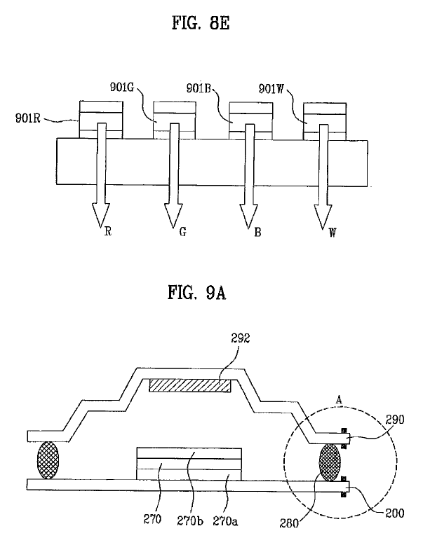

Next, FIG. 8A illustrates a plan view of an organic electro-luminescence device according to another embodiment of the present invention. As shown in FIG. 8A, the organic electro-luminescence device includes a first substrate 200, a second substrate 290 facing the first substrate 200, a light-emitting part 300 disposed on the first substrate 200, a number of unit pixels 350 disposed in the light-emitting part 300, a sealing portion 280 disposed around the light-emitting part 300 to stick the second substrate 290 onto the first substrate 200, and a driving part 400 which applies signals to the light-emitting part 300.

An organic light-emitting layer in the light-emitting part 300 emits light by a recombination of electrons and holes injected from the opposite electrodes. The light emission may be classified into fluorescence and phosphorescence according to the light-emitting manner. Further, the fluorescence has low efficiency (an internal efficiency of about 20% and a maximum external efficiency of about 5%), while it has relatively excellent lifetime characteristics. Also, the phosphorescence has high efficiency (an internal efficiency of about 100% and a maximum external efficiency of about 20%), while it has a disadvantage of a relatively short lifetime. The organic light-emitting layer may be formed of a fluorescent material or a phosphorescent material. The fluorescent/phosphorescent material and a dopant used in the organic light-emitting layer may vary according to colors of pixels.

In addition, sealing portion 280, which seals the light-emitting part 300 by sticking the second substrate 290 on the first substrate 200, may be a sealant or frit. For example, the sealant may be made of acrylic resin or the like.

Generally, an organic film has a water blocking performance of 10⁰ g/m²day, and an inorganic film has a water blocking performance of 10⁻¹ g/m²day. The display device generally requires a water blocking performance of 10⁻² g/m²day or more. Thus, a frit is a material having sealing characteristics showing an oxygen blocking performance of 10⁻³ cc/m²day or more and has an excellent water and oxygen blocking performance.

Specifically, the frit may be formed of an IR hardenable material as a material having sealing characteristics. For example, the frit may mainly include potassium oxide (K₂O), iron oxide (Fe₂O₃), antimony oxide (Sb₂O₃), zinc oxide (ZnO), phosphoric acid (P₂O₅), vanadium oxide (V₂O₅), titanium oxide (TiO₂), aluminum oxide (Al₂O₃), tungsten oxide (WO₃), bismuth oxide (Bi₂O₃), silicon oxide (SiO₂), boron oxide (B₂O₃), lead oxide (PbO), barium oxide (BaO), tellurium oxide (TeO) or the like.

Further, a frit may include a filler. For example, the filler may include low-expansion ceramic powder such as cordierite, zirconyl phosphate, β-eucryptite, β-spodumene, zircon, alumina, mullite, silica, β-quartz solid solution, zinc silicate, and aluminum titanate. The filler serves to adjust a thermal expansion coefficient of the frit corresponding to a thermal expansion coefficient of a glass substrate. If the glass substrate and the frit have different thermal expansion coefficients, the frit and the glass substrate are deformed in a different way according to a temperature change. Accordingly, stress may be generated at a boundary between the frit and the glass substrate, thereby bending or damaging the frit or the glass substrate. Thus, the glass substrate and the frit preferably have substantially the same thermal expansion coefficients.

Further, the filler may serve to increase the degree of crystallinity of the frit. In this instance, the crystallized glass such as a frit may be crystallized by heat treatment. That is, nuclei grow at some isolated cracks, that is, at phase boundaries of impurities, in melted glass to form a large crystal. A finally crystallized crystalline structure preferably have a grain diameter of 0.1 to 1 μm.

In the crystallization process, 90 percent or more of a glass material may be crystallized. Thus, a small amount of residual glass which is not crystallized occupies the volume of crystal grains. In this instance, it is possible to improve mechanical reliability of the glass by removing pores, which reduce a mechanical impact resistance of glass. Further, it is possible to improve a mechanical impact resistance by a low thermal expansion coefficient of glass materials.

Further, the frit may include one or more filling material or additive to adjust the thermal expansion characteristics of the sealing material and absorption characteristics according to the selected frequency. In this instance, the filling material or additive may additionally include zinc silicon oxide (ZnSiO₄), lead titanium oxide (PbTiO₃), zirconium oxide (ZrO₂) and eucrytite.

Further, the frit may include a transition metal. The transition metal can adjust thermal expansion characteristics of the frit and absorption characteristics of a laser beam to be irradiated later according to a frequency. Further, the transition metal has a high absorptance at a wavelength range of 800 nm. Thus, the transition metal serves to prevent the frit from transmitting light as the frit fails to absorb light when a laser beam is irradiated on the frit. In this instance, the transition metal may include, for example, chromium (Cr), iron (Fe), manganese (Mn), cobalt (Co), copper (Cu), vanadium (V) or the like.

Further, the frit is coated on a groove of a sealing substrate using a frit paste having the above materials by a dispensing method or a screen printing method. In this instance, the frit is preferably formed to have a height of 4 to 20 μm. If the height of the frit is 4 μm or more, there is an advantage of preventing the second substrate from being contacted with the light-emitting part of the first substrate. If the height of the frit is 20 μm or less, there is an advantage of preventing the display device from being excessively thick, thereby realizing a thin display device.

Further, the frit may be formed to have a width of 0.2 to 2 mm. If the width of the frit is 0.2 mm or more, it is possible to improve an adhesive strength between the first substrate and the second substrate. If the width of the frit is 2 mm or less, it is possible to prevent the light-emitting part from being reduced due to a large width of the frit, thereby improving an opening ratio.

Then, after the second substrate with the coated frit and the first substrate are aligned and attached to each other, a laser beam is irradiated on the frit. In this instance, the frit depends on an optical property of the irradiated laser beam. Further, a laser having a wavelength range of 800 to 900 nm, for example, a Ti-Sapphire laser having a wavelength of 800 nm, a carbon dioxide (CO₂) laser, an infrared lamp having a wavelength of 810 nm and a semiconductor laser having a wavelength of 800 to 900 nm, may be used.

In addition, the first substrate and the second substrate may have a higher glass softening point than that of the frit. Accordingly, when a laser beam is irradiated on the frit to attach the first substrate and the second substrate to each other, it is possible to prevent the first substrate and the second substrate from being damaged due to the high-temperature laser beam.

Also, barcodes are disposed on the first substrate 200 and the second substrate 290, respectively. Further, the second substrate 290 may be a packaging plate and the same manner is also applied to the following description.

Each of the barcodes is preferably formed to include a text barcode and a two-dimensional barcode. The text barcode is formed as designated by a reference numeral 100b in FIG. 5A and the two-dimensional barcode is formed as designated by a reference numeral 100a in FIG. 5A. Further, each barcode is formed on a surface of the organic electro-luminescence device to face the light-emitting layer or a surface of the organic electro-luminescence device to face the outside. The surface facing the light-emitting layer is a surface facing the inside of the organic electro-luminescence device and the surface facing the outside is a surface opposite to the surface facing the light-emitting layer.

FIGS. 8B to 8E illustrate embodiments for realizing a color image in the organic electro-luminescence device shown in FIG. 8A. Hereinafter, a method for realizing a color image in the organic electro-luminescence device shown in FIG. 8A will be described with reference to FIGS. 8B to 8E.

First, FIG. 8B shows a method for realizing a color image in the organic electro-luminescence device additionally including a red organic light-emitting layer 601R, a green organic light-emitting layer 601G and a blue organic light-emitting layer 601B which emit red, green and blue light, respectively. In this instance, red, green and blue light are emitted from the respective light-emitting layers to display a color image.

In a method for realizing a color image shown in FIG. 8C, color filters are disposed on a white organic light-emitting layer. Specifically, there are provided a white organic light-emitting layer 701W, a red color filter 703R, a green color filter 703G and a blue color filter 703B. Accordingly, white light emitted from the white organic light-emitting layer 701W transmits the red color filter 703R, the green color filter 703G and the blue color filter 703B to produce red light, green light and blue light, respectively, thereby displaying a color image.

In a method for realizing a color image shown in FIG. 8D, color changing media are disposed on a blue organic light-emitting layer. Specifically, a red color changing medium 803R and a green color changing medium 803G are disposed on a blue organic light-emitting layer 801B. Accordingly, blue light emitted from the blue organic light-emitting layer 801 B transmits the red color changing medium 803R and the green color changing medium 803G to produce red light, green light and blue light, respectively, thereby displaying a color image.

In a method for realizing a color image shown in FIG. 8E, four pixels form a unit pixel differently from the above-mentioned embodiments. Specifically, it is a method for realizing a color image in the organic electro-luminescence device additionally including a red organic light-emitting layer 901R, a green organic light-emitting layer 901G, a blue organic light-emitting layer 901B and a white organic light-emitting layer 901W. In this instance, a brightness ratio of light emitted from the respective red organic light-emitting layer 901R, the green organic light-emitting layer 901G, the blue organic light-emitting layer 901B and the white organic light-emitting layer 901W is set to be 2.6:6.6:1.1:12.5 to realize full colors with high efficiency.

Although not shown in the drawings, as four pixels forming a unit pixel, a red color filter, a green color filter, a blue color filter and a white color filter may be disposed on a white organic light-emitting layer. Further, color filters of different colors may be provided in addition to the above-described red/green/blue/white color filters. That is, it is possible to form a unit pixel by providing color filters having colors required in the device.

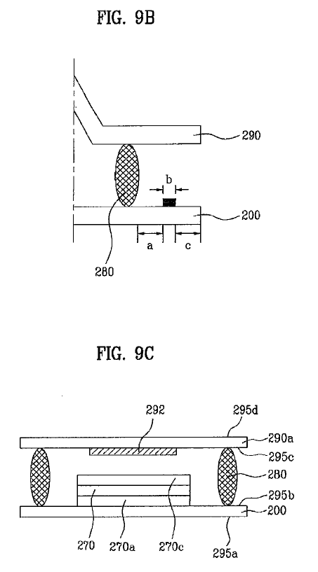

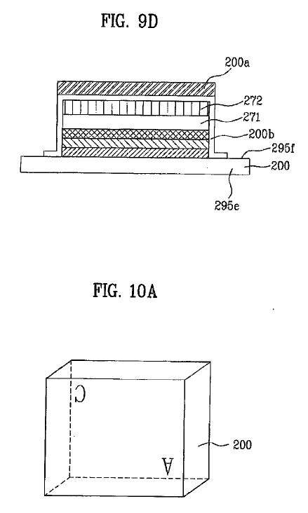

FIGS. 9A to 9C schematically illustrates a position of forming the above-described barcode. That is, the barcode may be formed at any place on opposite surfaces of the substrate 200 and opposite surfaces of the packaging plate 290. Further, although each barcode is disposed only outwardly from the sealing portion 280, the barcode may be also disposed inwardly from the sealing portion 280 as will be described later. However, the barcode preferably does not overlap with a light-emitting region.

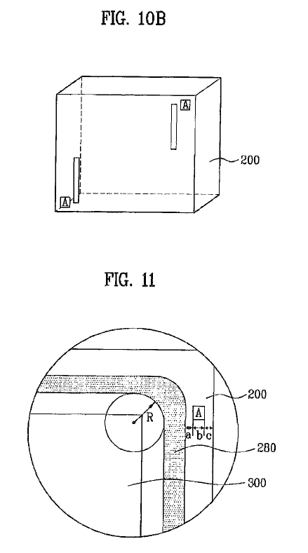

Further, the barcode may be formed to be viewed as an erect image on a light-emitting surface. As shown in FIG. 10A, for example, the barcode may be formed to have vertically inverted “C” or laterally inverted “A”. That is, a text written on the rear surface of the substrate 200 in FIG. 8 can be viewed as an erect image when the substrate 200 is vertically or laterally inverted. FIG. 10B illustrates the barcode having a vertical “A”. Generally, because the organic electro-luminescence device emits light through one side surface thereof, the barcode may be formed to be viewed as an erect image only in the light-emitting part. However, when the plural barcodes are printed in opposite lateral or vertical directions, the barcodes can be easily recognized on both the front surface and the rear surface of the organic electro-luminescence device.

Further, one of the plural barcodes may be printed by a laser and the other one may be printed by an inkjet method. In this instance, the barcode printed by a laser may have permanence and the barcode printed by an inkjet method allows easy error correction. Accordingly, the barcodes can be applied to a small-sized display device differently from a manual labor using a marking pen, thereby improving productivity. Further, it is easy to repair barcodes differently from a marking method using a sticker. Also, even when the barcode is wrongly marked on the substrate, the substrate can be saved

Further, as shown in FIG. 9A, the barcode is disposed on the substrate 200 or the packaging plate 290 outwardly from the sealing portion 280. In this instance, the barcode may be disposed on a side portion of the substrate 200 or the packaging plate 290 or an edge portion thereof (as shown in FIG. 8). Further, FIG. 9B illustrates an enlarged view of a portion indicated by a circle A as shown in FIG. 9A.

When an organic electro-luminescence device has a large-scale screen of 42 inches or larger, the barcode is preferably formed to be spaced by about 1˜10 mm (i.e., ‘a’) from the substrate 200 or the packaging plate 290. Further, the barcode is preferably formed to be spaced by about 1˜5 mm (i.e., ‘c’) inwardly from an outline of the substrate 200 or the packaging plate 290. That is, in FIG. 9B, a distance from the sealing portion to the barcode is indicated by ‘a’, and a width of the barcode and a distance from the barcode to the outline of the substrate 200 are indicated by ‘b’ and ‘c’, respectively.

Further, a ratio of the distance from the sealing portion 280 to the barcode to the distance from the barcode to the substrate 200 (or the packaging plate 290) is preferably 1.5:1 to 3.5:1. Further, a ratio of the width of the barcode to the distance from the barcode to the outline of the substrate 200 (or the outline of the packaging plate 290) is preferably 1.2:1 to 2.5:1.

When an organic electro-luminescence device has a size of about 2.2 inches, there is a blank of about 4 mm on the substrate outwardly from the sealing portion 280. Because the blank of about 4 mm is a portion which is connected to a driver IC, a smaller black may be formed in the other portions.

The barcode is also preferably formed to be spaced by a specified distance from the outline of the substrate due to limitations of a laser etching technology or an ink coating technology. Further, the barcode is preferably formed to be spaced by a specified distance from the sealing portion for the same reason. That is, when the barcode is formed by a laser etching method, a margin is used not to damage a lower layer and/or a light-emitting layer. Accordingly, it may be difficult to form a text, a mark or the like. Because the size of a light-emitting screen should be reduced in order to increase a margin width, an effective screen is reduced. Further, if the size of a light-emitting screen is not reduced while maintaining a large margin width, the size of a mother glass and a sealing film should be large, thereby increasing the cost. Further, if a small margin width is formed, because a peripheral portion of the light-emitting region is very complicated, an interference phenomenon may occur and a design becomes very difficult.

Further, preferably, an insulating film is not formed on a barcode formation portion of the substrate 200. That is, preferably, the barcode is viewed from both an upper portion and a lower portion of the substrate (or the packaging plate). When the insulating film is not formed on the barcode formation portion, even though the barcode is formed on the inside of the device, the barcode can be viewed from the outside of the device. Further, the organic electro-luminescence device may be an active matrix type device. In this instance, at least one of a Vdd line and a Vss line may be disposed at the barcode formation portion of the substrate. The Vdd line and the Vss line may be formed of a transparent electrode such as indium tin oxide (ITO).

The data lines and the power lines may be positioned at a non-pixel region and formed of a single layer or multiple layers. If the data lines and the power lines are formed of a single layer, they may be formed of any one selected from a group consisting of molybdenum (Mo), aluminum (Al), chromium (Cr), gold (Au), titanium (Ti), nickel (Ni), neodymium (Nd) and copper (Cu) or an alloy thereof, but it is not limited thereto. Further, if the data lines and the power lines are formed of multiple layers, they may be formed of double layers of molybdenum/aluminum-neodymium, molybdenum/aluminum or titanium/aluminum, or triple layers of molybdenum/aluminum/molybdenum, molybdenum/aluminum-neodymium/ molybdenum or titanium/aluminum/titanium. In this instance, the data lines serve to supply data signals to the respective pixels. That is, the data lines supply data signals to the respective pixels from a data driver disposed at the outside of a pixel region.

Further, when the barcode is disposed on the edge portion of the substrate (or the packaging plate), an anti-static electricity pad may be disposed in the vicinity of the barcode. The “vicinity” is used to mean that the anti-static electricity pad is not necessarily disposed within a specified numerical range, and the anti-static electricity pad is also disposed on the edge portion of the substrate or the like. Further, the anti-static electricity pad may discharge static electricity stored in a cathode electrode or the like in forming the device to the outside of the device in order to prevent a malfunction of the device and an interference phenomenon. FIG. 10B illustrates the substrate 200, in which a pair of barcodes is formed at diagonal corners of the substrate 200 and anti-static electricity pads are formed in the vicinity of the barcodes.

FIG. 9C illustrates an organic electro-luminescence device according to another embodiment of the present invention, and which includes a metal cap structure. As shown in FIG. 9C, the transparent substrate 200 and a glass cap 290a may be attached to each other with a sealant 280 interposed therebetween. Further, barcodes 295a to 295d are formed on the transparent substrate 200 outwardly from the sealant 280. FIG. 9D illustrates an organic electro-luminescence device according to still another embodiment of the present invention. In this instance, an organic layer 271 and the like on the substrate 200 are sealed by an adhesive layer 200b, and a metal layer 200a is disposed at the top thereof to face the substrate 200. In this instance, the metal layer 200a may be formed of ceramic or the like instead of metal. Further, barcodes 295e and 295f may be disposed on the substrate 200 outwardly from the adhesive layer 200b.

Further, an align mark may be formed in the vicinity of the barcode formation portion or the edge portion of the substrate. That is, the align mark is an indication for combining the substrate with the packaging plate. The align mark may be used to check a barcode formation position. Because there is no insulating film in the vicinity of the edge portion, although the barcode is formed on the inside of the substrate, the barcode can be viewed from the outside of the device. Further, metal lines or transparent electrode (ITO, IZO) lines may be disposed at the barcode formation portion at the edge of the substrate since the metal lines or transparent electrode (ITO, IZO) lines are transparent so as not to interrupt reading of the barcode.

FIG. 11 illustrates a plan view showing an enlarged view of a portion indicated by a circle A as shown in FIG. 8A. Hereinafter, a curved portion of the organic electro-luminescence device according to the embodiment of the present invention will be described in detail with reference to FIGS. 8A and 11.

As shown in the drawings, the sealing portion 280 may include a linear portion which is linearly coated around the light-emitting part 300 and a curved portion which is curvedly coated at the edge portion of the light-emitting part 300. Further, the curved portion of the sealing portion 280 is preferably formed to have a curvature radius R of 0.2 to 2.5 mm. If the curved portion of the sealing portion 280 has a curvature radius R of 0.2 mm or more, after the seal for combining substrates is coated, it is easy to control the amount of the seal pushed outward and it is possible to facilitate panel scribing which is influenced by the seal pushed outward. Further, if the curved portion of the sealing portion 280 has a curvature radius R of 2.5 mm or less, it is possible to prevent an increase of a bezel region or a reduction of a light-emitting part due to an increased curvature radius R of the curved portion of the sealing portion 280.

Further, the linear portion and the curved portion of the sealing portion 280 preferably has a width ratio of 1:1 to 1:1.5. If the linear portion and the curved portion of the sealing portion 280 has a width ratio of 1:1 or larger, it is possible to prevent reduction of adhesive strength of the curved portion due to a small width of the curved portion of the sealing portion 280. Also, it is easy to ensure processing conditions for controlling the discharge amount of the seal. Further, if the linear portion and the curved portion of the sealing portion 280 has a width ratio of 1:1.5 or smaller, it is possible to prevent an increase of a bezel region and an increase of the size of the panel due to an increased width of the curved portion of the sealing portion 280.

Further, the barcode is formed in the vicinity of the edge portion of the substrate 200 in FIG. 11, where a distance from the sealing portion 280 to the barcode is indicated by ‘a’, and a width of the barcode and a distance from the barcode to the outline of the substrate 200 are indicated by ‘b’ and ‘c’, respectively.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An organic electro-luminescence device, comprising:
a substrate;
a first electrode, a light-emitting layer and a second electrode sequentially formed on the substrate;
a packaging plate facing the substrate; and
barcodes formed on the substrate and the packaging plate.

2. The organic electro-luminescence device according to claim 1, wherein each of the barcodes includes a text barcode and a two-dimensional barcode.

3. The organic electro-luminescence device according to claim 2, wherein each of the barcodes is formed on a surface of the organic electro-luminescence device to face the light-emitting layer.

4. The organic electro-luminescence device according to claim 2, wherein each of the barcodes is formed on a surface of the organic electro-luminescence device to face an outside.

5. The organic electro-luminescence device according to claim 1, wherein each of the barcodes is viewed as an erect image on a light-emitting surface of the organic electro-luminescence device.

6. The organic electro-luminescence device according to claim 1, wherein one of the barcodes is printed by a laser and the other one is printed by an inkjet method.

7. The organic electro-luminescence device according to claim 1, wherein an insulating layer is absent from a barcode formation portion of the substrate.

8. The organic electro-luminescence device according to claim 1, wherein the organic electro-luminescence device is an active matrix type device and at least one of a Vdd line and a Vss line is disposed on the substrate corresponding to the barcodes.

9. An organic electro-luminescence device, comprising:
a substrate;
a first electrode, a light-emitting layer and a second electrode sequentially formed on the substrate;
a packaging plate facing the substrate; and
a barcode formed on an edge of at least one of the substrate and the packaging plate.

10. The organic electro-luminescence device according to claim 9, wherein the barcode is formed at an outer portion of the substrate and the packaging plate and is spaced by about 1˜10 mm from a sealing portion.

11. The organic electro-luminescence device according to claim 9, wherein the barcode is formed to be spaced by about 1˜5 mm from an outline of the substrate or the packaging plate.

12. The organic electro-luminescence device according to claim 9, further comprising an anti-static electricity pad disposed in a vicinity of the barcode.

13. The organic electro-luminescence device according to claim 9, wherein the barcode formed on the substrate is formed in a vicinity of an align mark.

14. An organic electro-luminescence device, comprising:
a substrate;
a first electrode, a light-emitting layer and a second electrode sequentially formed on the substrate;
a packaging plate facing the substrate; and
barcodes formed on the substrate and the packaging plate,
wherein the barcodes are disposed outwardly from a sealing portion.

15. The organic electro-luminescence device according to claim 14, wherein a ratio of a distance from the sealing portion to the barcodes to a distance from the barcodes to the substrate or the packaging plate is 1.5:1 to 3.5:1.

16. The organic electro-luminescence device according to claim 14, wherein a ratio of a width of the barcodes to a distance from the barcodes to an outline of the substrate or the packaging plate is 1.2:1 to 2.5:1.

17. The organic electro-luminescence device according to claim 14, wherein the sealing portion includes a sealant or frit.

18. The organic electro-luminescence device according to claim 14, wherein the sealing portion includes a curved portion and the curved portion has a curvature radius R of 0.2 to 2.5 mm.

19. The organic electro-luminescence device according to claim 18, wherein the sealing portion includes the curved portion and a linear portion, and a width ratio of the linear portion and the curved portion is 1:1 to 1:1.5.

20. An organic electro-luminescence device, comprising:
a substrate;
a first electrode, a light-emitting layer and a second electrode sequentially formed on the substrate;
a packaging plate facing the substrate; and
a first barcode and a second barcode formed on the substrate and the packaging plate, respectively,
wherein the first barcode and the second barcode are inverted to each other.

21. The organic electro-luminescence device according to claim 20, wherein the first barcode and the second barcode are vertically or laterally inverted to each other.

22. The organic electro-luminescence device according to claim 20, wherein the first barcode and the second barcode are formed on a surface of the organic electro-luminescence device to face the light-emitting layer or a surface of the organic electro-luminescence device to face an outside.

23. The organic electro-luminescence device according to claim 20, wherein the first barcode is a text barcode and the second barcode is a two-dimensional barcode.

24. An organic electro-luminescence device, comprising:
a substrate;
a first electrode, a light-emitting layer and a second electrode sequentially formed on the substrate;
a packaging plate facing the substrate; and
a first barcode and a second barcode formed on the substrate and the packaging plate, respectively,
wherein the first barcode is formed by printing ink and the second barcode is formed by etching with a laser.

25. The organic electro-luminescence device according to claim 24, wherein the first barcode and the second barcode are disposed on an edge of the substrate or the packaging plate.

26. The organic electro-luminescence device according to claim 25, further comprising at least one of an anti-static electricity pad and an align mark in a vicinity of the first barcode and/or the second barcode.
